(19) United States
(12) Patent Application Publication
(10) Pub. No.: US 2023/0122595 A1
(43) Pub. Date: Apr. 20, 2023

(54) Thermal energy storage for urban concentrated solar power

(71) Applicant: Suncom Energy, B.V., Utrecht (NL)

(72) Inventors: Hendrikus Petrus Maria Arntz, Utrecht (NL); Waltherus Johannes Gubbels, Eindhoven (NL)

(21) Appl. No.: 17/968,093

(22) Filed: Oct. 18, 2022

Related U.S. Application Data
(60) Provisional application No. 63/257,678, filed on Oct. 20, 2021.
(60) Provisional application No. 63/310,795, filed on Feb. 16, 2022.
(60) Provisional application No. 63/415,515, filed on Oct. 12, 2022.

(51) Int. Cl. F28D 20/00; F28F 1/12

(52) U.S. Cl. CPC F28D 20/0056; F28F 1/12; F28D 2020/0078; F28D 2020/0069; F28F 2210/10

(57) ABSTRACT

A heat exchanger is provided capable of exchanging heat received from a concentrated solar power plant via heat exchanging pipes and conducting the heat via patterns of flexible heat conducting cables into heat storing solids. The heat exchanger is further capable of exchanging heat stored by heat storing solids via the patterns of flexible heat conducting cables to heat exchanging pipes for use by a heat consumer. The heat exchanger has a charging and a discharging speed of a heat exchanger is about 50 kW/m³ or at least 50 kW/m³.

### CROSS-REFERENCE TO RELATED APPLICATIONS

This application claims priority from U.S. Provisional Patent Application 63/257,678 filed Oct. 20, 2021, which is incorporated herein by reference. This application claims priority from U.S. Provisional Patent Application 63/310,795 filed Feb. 16, 2022, which is incorporated herein by reference. This application claims priority from U.S. Provisional Patent Application 63/415,515 filed Oct. 12, 2022, which is incorporated herein by reference.

### FIELD OF THE INVENTION

The present invention relates generally to energy storage. More particularly, the invention relates to thermal energy storage that contains a heat transferring fluid and a heat storing solid.

### BACKGROUND OF THE INVENTION

A change from fossil to sustainable energy increases the demand for sustainable energy generated in the proximity of a user. With an increase in the amount of intermittent sustainable energy, the demand to store such sustainable energy is growing.

Concentrated Solar Power (CSP) is a technology where sunlight is concentrated onto a heat receiver. One of the CSP technologies is a parabolic trough that concentrates the sunlight onto the heat receiver. The heat receiver is a metal duct that contains a Heat Transferring Fluid (HTF). Generally, these ducts are encapsulated and evacuated in a glass cylindrical tube. Examples of an HTF are water to create steam or another medium such as synthetic oil or molten salt to create steam at a later stage.

Heating an HTF to a high temperature of about 550 degrees Celsius is desirable to enable a high Carnot efficiency of a Rankine cycle. Storage of this high temperature HTF is known as Thermal Energy Storage (TES).

Currently, thermal energy storage is achieved by using liquids like molten salt and lower cost heat storing solutions of solids like basalt and concrete. However, the challenge of these solid heat storing solids is their low conductivity, limiting the charging and discharging speed. Solid heat storing solutions are desired to not only have low-cost heat storage, but also a heat conductivity above the current 1 W/mK to 5 W/mK or higher, to ensure a high charge and discharge speed. 1 W/mK is a common heat conductivity in the art for heat storing solids like basalt and concrete. The present invention addresses the problem.

### SUMMARY OF THE INVENTION

The present invention provides in one embodiment a system for thermal energy storage for urban Concentrated Solar Power (CSP). Urban indicating a small scale (50 kWe-5 MWe) plant unlike state of the art large scale CSP (50-700 MWe) The system includes a concentrated solar power plant producing heat, a heat consumer and a heat exchanger. The heat exchanger receives heat from the concentrated solar power plant and converts it to an output to a heat consumer. The heat exchanger can be embodied as part of the system or separately as an apparatus.

The heat exchanger has a plurality of heat exchanging pipes (made from a metallic material) distributed within a volume of the heat exchanger. The plurality of heat exchanging pipes runs in a direction more or less parallel to each other. Each of the plurality of heat exchanging pipes define an outer diameter ranging from 8 mm to 30 mm. The volume of heat exchanging pipes (outer diameter times length) within the volume of the heat exchanger ranges from 1 to 10 volume percent.

The heat exchanger further has a plurality of patterns distributed within the volume of the heat exchanger. Each of the plurality of patterns pattern is formed by one or more heat conducting cables. One or more heat conducting cables form one of the plurality of patterns by connecting at least some of the plurality of heat exchanging pipes and by wrapping around the outer diameter of at least some of the plurality of heat exchanging pipes establishing contact surface area between one of the heat exchanging pipes and the one or more heat conducting cables. The one or more heat conducting cables are Aluminum cables, stranded Aluminum cables or recycled Aluminum power cables. The outer diameter of each of the one or more heat conducting cables ranges from 1 mm to 20 mm.

The heat exchanger further has heat storing solids (e.g. Basalt rocks or Steelslag.) distributed within the volume of the heat exchanger and in between the plurality of heat exchanging pipes and plurality of patterns. The heat storing solids are rocks of varying sizes ranging from 1 mm to 100 mm.

The number of heat conducting cables and the number of heat storing solids combined within the volume of the heat exchanger ranges from 90 to 99 volume percent.

The heat exchanger exchanges heat received from a concentrated solar power plant via the plurality of heat exchanging pipes and conducting the heat via the plurality of patterns into heat storing solids, and the heat exchanger exchanges heat stored by heat storing solids via the plurality of patterns to the plurality of heat exchanging pipes for use by a heat consumer. The heat exchanger has a charging and a discharging speed of a heat exchanger is about 50 kW/m³ or at least 50 kW/m³. In another embodiment, the invention is a method of exchanging heat according to the design of the heat exchanger as described herein.

Embodiments of the invention result in an increase in the heat conductivity above 5 W/mK to increase the charge and discharge speed to the desired 50 kW/m³. For example, 50 kW of thermal power can be charged or discharged per cubic meter (m³) of heat storing solid. At a heat conductivity of 1 W/mK, like basalt, it would require almost 200 heat exchanger pipes of 1 inch in 1 m³ of basalt (1 inch pipe outer diameter is a common traded pipe size). For example, over 10% of the basalt volume is consumed with expensive heat exchanger pipes. An increase of the heat conductivity of the heat storing solid to 10 W/mK will decrease the amount of 1 inch heat exchanger pipes to 36 at the same 50 kW/m³ charging speed. These 36 pipes form a matrix of 6×6 per 1 m³ of heat storing solid and only consume 2% of the heat storing volume. The same 36 1 inch heat exchanger pipes at a heat conductivity of 1 W/mK would only enable a charging and discharging speed of 5 kW/m³. For example, embodiment of this invention enables a 10 times (50/5) higher charging and discharging speed at negligible cost increase in comparison to heat storing solids like basalt and concrete. These exemplary numbers for such an argumentation are at a temperature difference between HTF temperature and bulk temperature of heat storing solid of 50K as explained in FIG. 6.

### BRIEF DESCRIPTION OF THE DRAWINGS

FIG. 1 shows a schematic of an urban Concentrated Solar Power (CSP) plant 100 according to an exemplary embodiment of the invention. In one example thermal energy storage tank 104 could be insulated (not shown).

FIG. 2 shows a thermal energy storage tank 104 according to an exemplary embodiment of the invention including heat exchanger unit or matrix 108 and heat transfer fluid tank 110.

FIG. 3 shows a schematic two-dimensional detail of a heat exchanger unit or matrix 108 according to an exemplary embodiment of the invention. Heat exchanger unit or matrix 108 contains heat exchanging pipes 310, heat storing solids 330, 340 and heat conducting cables 320 in pattern 320-P defined from start to end. The outer diameter of heat exchanging pipes is defined as the outer diameter of heat exchanging pipes 310. Contact surface area is defined where heat conducting cables 320 make contact with the heat exchanging pipes 310.

FIG. 4 shows a schematic two-dimensional detail of a heat exchanger unit or matrix 108 according to a different exemplary embodiment of the invention. Heat exchanger unit or matrix 108 contains heat exchanging pipes 310, heat storing solids (not shown, but similar as in FIG. 3) and a heat conducting pattern or template 410. Noted is that the template only goes around the center/middle three pipes 310 but as an skilled artisan would readily appreciate is that the template would go around all pipes 310 in template 410.

FIG. 5 shows a schematic two-dimensional detail perpendicular to the view in FIG. 3 of a heat exchanger unit 108 according to an exemplary embodiment of the invention.

FIG. 6 shows an area specific number of pipes as a function of thermal conductivity for different charging and discharging speeds according to an exemplary embodiment of the invention.

### DETAILED DESCRIPTION

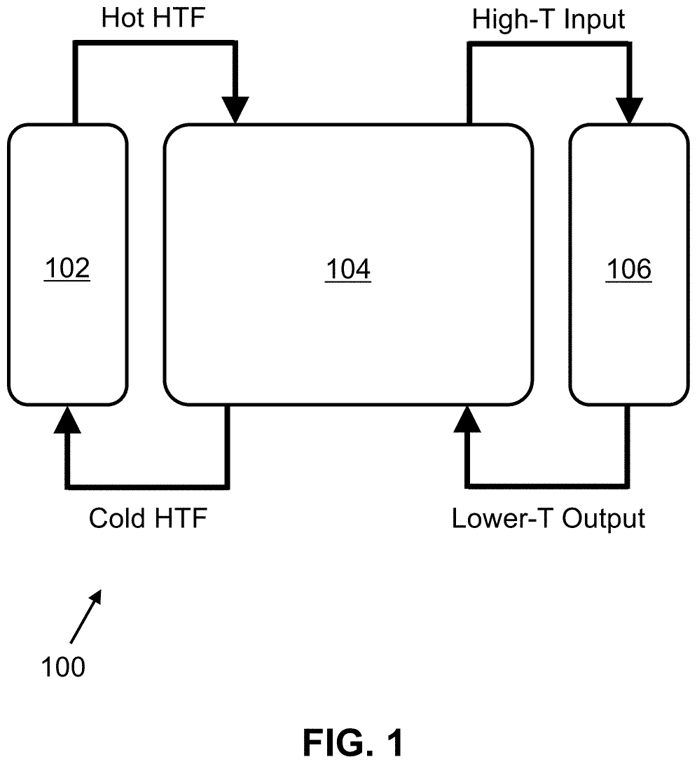

FIG. 1 shows a schematic view 100 of an urban Concentrated Solar Power (CSP) plant with a solar field 102 with a Thermal Energy Storage (TES) tank 104 and a Heat Consumer 106 that can utilize heat or use heat for energy generation. Examples of Heat Consumer 106 are, without limitation, a Ranking Cycle, a House, a Greenhouse, a Factory or any other system of structure that would utilize heat. Solar field 102 typically contains one or more reflectors and receivers to generate heat by concentrating light from the sun. Such heat can reach temperature of about 550 degrees Celsius and is herein referred to as Hot Heat Transfer Fluid (Hot HTF). It is noted that Hot HTF can be a fluid, a steam, or synthetic oil, molten salt or water.

Hot HTF transfer from Solar Field 102 to TES tank 104 where the heat can be transferred for storage and where heat can be discharged for usage by the Heat Consumer 106. Hot HTF is relatively higher in temperature and the output from TES tank 104 to Heat Consumer 106 which is referred to as High-T Input. Likewise, the output, referred to as Lower-T Output, from the Heat Consumer 106, back into TES tank 104, has a relatively lower temperature that the High-T input to Heat Consumer 106. Also, the output, referred to as Cold HTF from TES tank 104 has a relatively lower temperature than the Hot HTF input to TES tank 104. It is noted that heat can be consumed in different ways, like hot water, hot air, steam or another fluid at a temperature increased by the heat in the TES tank 104.

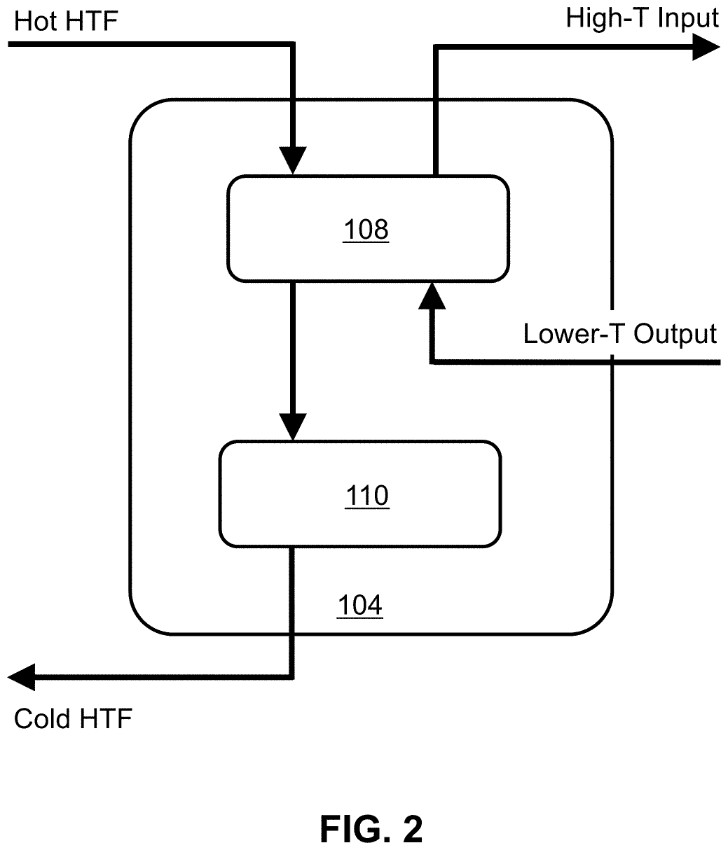

FIG. 2 shows TES tank 104 with a heat exchanger unit or matrix 108 and a heat transfer fluid tank 110. Heat from solar field 102 is received by heat exchanger unit or matrix 108, which then outputs a relatively lower temperature stream (relative to the input to heat exchanger unit or matrix 108) or output to heat transfer fluid tank 110. The objective for the TES tank 104 is to keep the capital expenditures for operation as low as possible to provide a competitive electricity price and heat price. This objective is achieved with a new design of heat exchanger unit or matrix 108 (FIG. 2). It is possible to add electric heating to either 108 and/or 110 to liquify an HTF like molten salt in 110 and prevent solidification in 108. This same electric heating can also be used to convert superfluous electricity from the grid into heat.

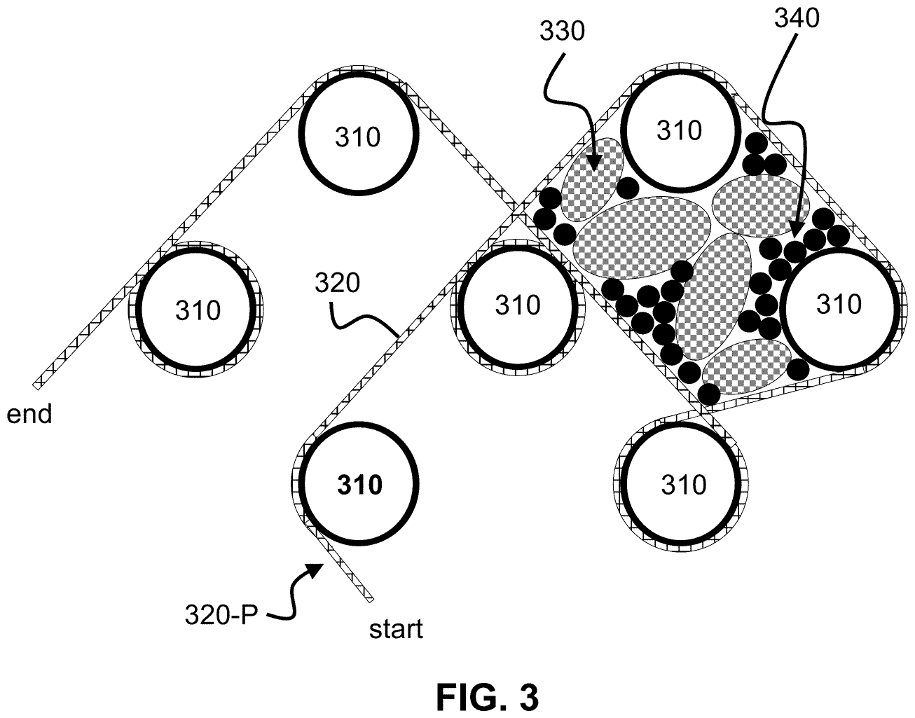

According to FIGS. 2-3, with that objective in mind, heat exchanger unit or matrix 108 was designed to contain heat exchanging pipes 310, heat storing solids 330, 340 and heat conducting cables 320 (FIG. 3) within a volume of the unit or matrix of the heat exchanger. With that design, heat exchanger unit or matrix 108 is capable of.
1) Exchanging the heat received via pipes 310 and conducting by heat conducting cables 320 into heat storing solids 330, 340. This is also referred to herein as charging heat storing solids 330, 340 or storing heat into heat storing solids 330, 340.
2) Exchanging the heat stored by heat storing solids 330, 340 via pipes 310 and conducting the heat by heat conducting cables 320 to Heat Consumer 106. This is also referred to as discharging heat from solids 330, 340.

Heat exchanging pipes 310 are pipes made out of metallic material with the purpose of transferring heat. Pipes 310 are arranged in a distributed fashion or array of pipes. A distribution range for the pipes, application dependent, is in the range of 1-10 volume percent within the heat exchanger unit 108. For example, 1-10 volume percent is composed of heat exchanging pipes 310 and the other 90-99 volume percent is composed of heat storing solids 330, 340 and heat conducting cables 320.

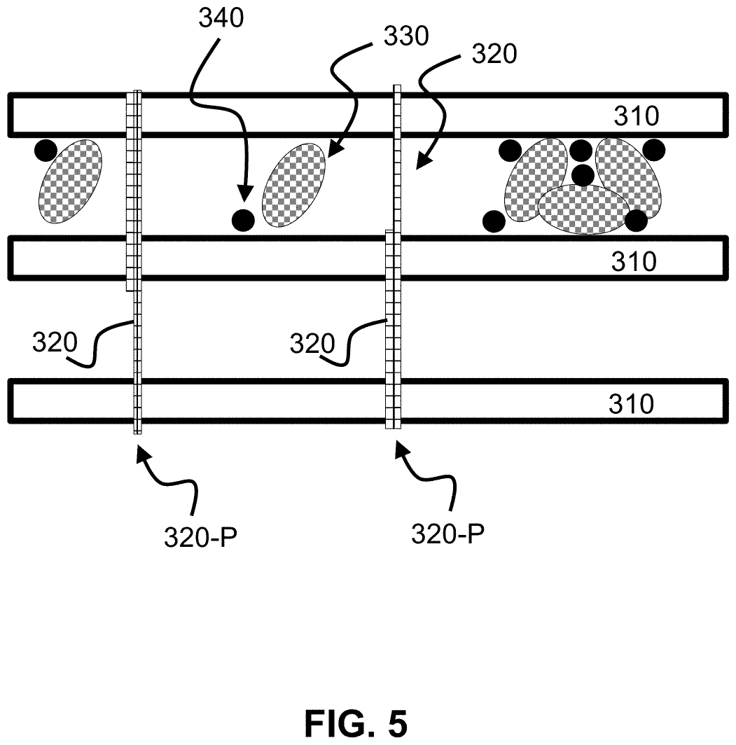

According to a preferred embodiment of the invention, heat conducting cables 320 are preferably Aluminum or predominantly Aluminum based alloys to establish high heat conducting cables (FIG. 3, FIG. 5). In another preferred embodiment, heat conducting cables 320 are flexible Aluminum cables or flexible stranded Aluminum cables 320 are wrapped around heat exchanger pipes 310.

Aluminum has a relatively high heat conductivity. The use of stranded flexible Aluminum cables can either be manufactured or used from recycled electrical cabling. For the latter, this material is/was normally used as electricity cabling. It is of the highest quality aluminum, because that was necessary to run electricity through it. It was used as electricity conduction cable, even though copper has a higher electric conductivity and copper prices used to be higher. Nowadays, the electrical cables are being replaced by copper, so the Aluminum cabling is left as a common scrap material. An objective of this invention is to utilize these retired Aluminum cables for the purposes of the objective for the TES tank 104 stated supra.

As these Aluminum cables are flexible, they can be used as a single cable 320 and wrapped around pipes 310 in a pattern from start and end. Flexible is defined herein as being capable of wrapping around pipes 310. A preferred diameter of heat conducting cables 320 is in the range of 1 to 100 mm, or preferably in the range of 1 to 20 mm. As a skilled artesian would readily appreciate is that more than one heat conducting cables 320 can be used, and that each heat conducting cable 320 can wrap around a pipe 310 more than once. The goal of the wrapping and pattern design of the heat conducting cable(s) 320 is to:
1) Create a heat exchanging contact area or surface between pipes 310 and heat conducting cables 320 as the intermediary with the purpose to establish heat exchange between pipes 310 via cables 320 to establish heat exchange from pipes 310 and the heat storing solid 330 and 340, and
2) Create and connect adjacent pipes 310 as illustrated in FIG. 3 to thermally connect the heat exchanging pipes 310 to the heat storing solids 330 and 340 and reach a homogeneous temperature within the TES tank 108.

In one design, a plurality of patterns can be used wherein each patterns runs more or less orthogonal to the direction of the heat exchanging pipes 310. In another embodiment, a more complex design can be used. Depending on the chosen heat conducting cable 320 length, these patterns can be two dimensional, as shown in FIG. 5 or three dimensional (not shown). In the three dimensional case, one heat conducting cable 320 could be drawn (or wrapped) in a pattern along the length of the heat exchanger pipes 310 or in any variation as desired by the design objectives.

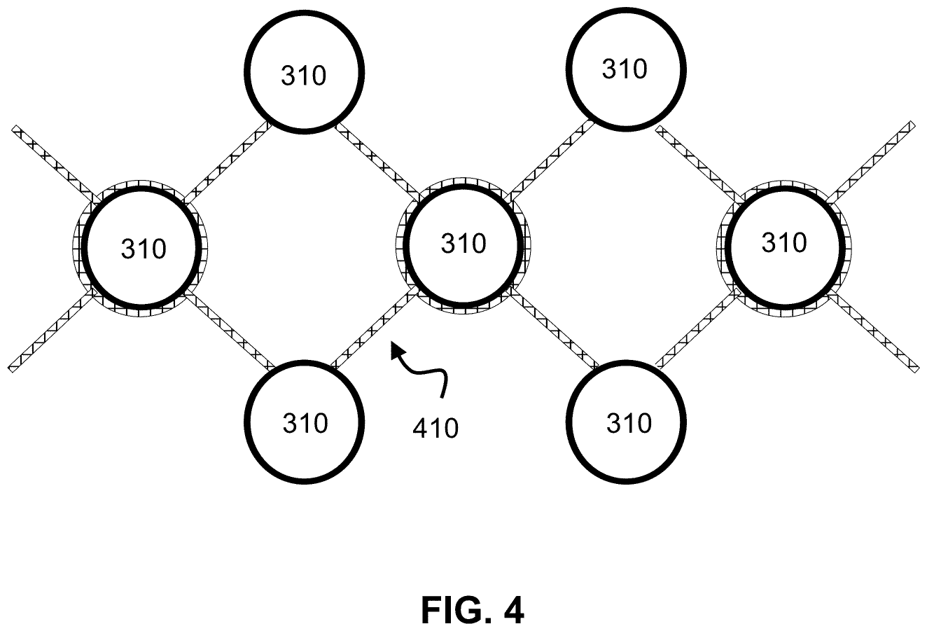

In another embodiment, heat exchanger unit or matrix 108 contains heat exchanger pipes 310, heat storing solids (not shown, but similar as in FIG. 3) and a heat conducting pattern or template 410 (FIG. 4, and a similar side view as shown in FIG. 5 for FIG. 3 could be envisioned for FIG. 4). Heat conducting pattern or template 410 could be a pre-stamped or fabricated template that fits pipes 310 with the same purpose as taught for the Aluminum cables or flexible stranded Aluminum cables (FIG. 3). For these pre-stamped or fabricated templates high heat conducting materials are desirable. In a preferred embodiment, Aluminum or predominantly Aluminum based alloys can be used, as well as the recycled flexible Aluminum cables or flexible stranded Aluminum cables which can be recycled into such templates. The goal of these templates is similar as discussed with respect to the cables shown in FIG. 3.

Heat storing solids of different sizes illustrated by 330, 340 can be used to absorb and store the heat. The smallest size are solids at very small particle diameter of around 1 mm. Larger sizes have a particle diameter of 10 times bigger in each step. For example, 1 mm, 10 mm, 100 mm etc. The goal in using different size solid and variations in diameter size is to establish a low void fraction. Void fraction is defined as the volume of air by the total TES tank 108 volume. Heat storing solids of different sizes enable a void fraction below 5%. Air is not desirable and should be minimized due to the low heat capacity, low thermal conductivity and heat transfer rate. Heat storing solids 330, 340 fill the space around pipes 310 and cables 320 (or template 410). In a preferred embodiment, these Heat storing solids are rocks such as Basalt rocks as they are known as excellent materials to hold heat yet transfer the heat slowly due to the low thermal conductivity of around 1 W/mK. In addition, Basalt is a relatively low-cost rock for heat storage. The combination of Aluminum with the Basalt rocks is then a perfect combination to provide for a cost-effective thermal energy storage at desired charging and discharging rates of around 50 kW/m³ (see infra for rational and design considerations).

Design Considerations

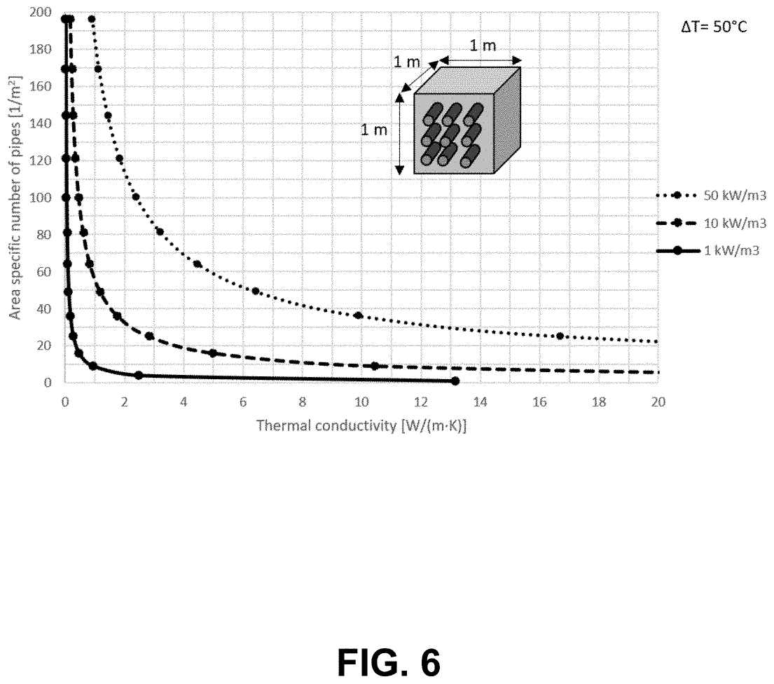

The relation between thermal conductivity of TES tank 108, the area specific number of heat exchanging pipes 310 and charging and discharging speeds is shown in FIG. 6. The graphs shown in FIG. 6 are based on a temperature difference ΔT of 50K and a heat exchanger pipe 310 outer diameter of 1 inch. The temperature difference ΔT of 50K is defined as the difference in temperature between a hot charging heat exchanger pipe 310 and the lowest temperature of a heat storing solid 330 and 340 in the TES tank 108.

At a heat conductivity of 1 W/mK, like basalt, it would require almost 200 heat exchanger pipes of 1 inch outer diameter in 1 m³ of basalt rocks. For example, over 10% of the basalt volume is consumed with expensive heat exchanger pipes, increasing cost and lowering heat storage capacity.

Increasing the heat conductivity of the total heat storing solids 330 and 340 and cables 320 combined to 10 W/mK will decrease the amount of 1 inch outer diameter heat exchanger pipes to 36 at the same charging speed of 50 kW/m³. These 36 pipes form a matrix of 6×6 per 1 m³ of heat storing solid and only consume 2% of the heat storing volume. The same 36 1 inch outer diameter heat exchanger pipes at a heat conductivity of 1 W/mK would only enable a charging and discharging speed of 5 kW/m³. For example, embodiments of this invention enable a 10 times (50/5) higher charging and discharging speed at negligible cost increase in comparison to heat storing solids like basalt and concrete.

Table 1 indicates some main options to store energy from an electrical point of view and states the associated costs in $/MWh_{electric}. Thermal Energy Storage techniques are converted to Electrical storage costs by incorporating a Rankine Cycle efficiency of 33%. Utility scale Li-ion batteries cost around $400,000/MWh_{electric}, where liquid CSP storage techniques like Oil and Molten Salt respectively only cost $150,000/MWh_{electric} and 45,000 $/MWh_{electric}. Solid Thermal Energy Storage technologies come at a significant lower cost, but their thermal conductivity is too low, leading to a low charging and discharging speed. Hence the limited number of applications in industry.

Table 1. Illustrates the cost of storage solutions in the art and according to embodiments of this invention. Embodiments of this invention provide a low cost (2,000 $/MWh_{electric}) solution yet still reaches a high (dis)charging speed of 50 kW/m³ due to the increased thermal conductivity of the bulk (heat storing solid and heat conducting cable combined).
cₚ is defined as heat capacity and determines the amount of energy a material in TES tank 108—like a heat storing solid—can store per unit mass per degree Kelvin [kJ/kgK].
K is defined as heat conductivity of the combined material in the TES tank 108 and is derived from the combination of the heat conductivity of the heat storing solid 330, 340 and cables 320.
V is defined as the (dis)charging speed of the TES tank 108 in power per volume of the TES tank 108 [kW/m³].
Cost is defined as the investment for each mentioned technology per amount of electric (equivalent) energy [$/MWh_{electric}].

| | | | | Molten | | | This |
|---|---|---|---|---|---|---|---|
| Property | Unit | Li-ion | Oil | salt | Basalt | Steelslag | invention |
| cₚ | kJ/kgK | — | 2.0 | 1.5 | 0.9 | 1.1 | 1.1 |
| k | W/mK | — | — | — | 1.6 | 1.2 | 10 |
| V | kWₜₕₑᵣₘₐₗ/m³ | — | | | 5 | 5 | 50 |
| Cost | $/MWh_{electric} | 400,000 | 150,000 | 45,000 | 10,000 | 1,000 | 2,000 |

As discussed, the low heat conductivity of basalt and steelslag form a challenge which as shown herein can be solved by heat conductive cables or strands. It was determined by the inventors that a 5% volume of aluminum by means of these heat conductive cables or strands, and according to exemplary design patterns shown herein, would already increase the thermal conductivity of the combined heat storing solids to 10 W/mK and only raise the cost from 1,000 to 2,000 $/MWh_{electric}. As such, embodiments of this invention would increase the charging and discharging speed of a Thermal Energy Storage (TES) from around 5 (as common in the art) to 50 kW/m³ at marginal cost increase.

What is claimed is:

1. A heat exchanger, comprising:
(a) a plurality of heat exchanging pipes distributed within a volume of the heat exchanger,
wherein the plurality of heat exchanging pipes runs in a direction more or less parallel to each other, and
wherein each of the plurality of heat exchanging pipes define an outer diameter;
(b) a plurality of patterns distributed within the volume of the heat exchanger,
wherein each of the plurality of patterns pattern is formed by one or more heat conducting cables, and
wherein the one or more heat conducting cables form one of the plurality of patterns by connecting at least some of the plurality of heat exchanging pipes and by wrapping around the outer diameter of at least some of the plurality of heat exchanging pipes establishing contact surface area between one of the heat exchanging pipes and the one or more heat conducting cables; and
(c) heat storing solids distributed within the volume of the heat exchanger and in between the plurality of heat exchanging pipes and plurality of patterns, wherein the heat storing solids are rocks of varying sizes.

2. The heat exchanger as set forth in claim 1, wherein the heat exchanger exchanges heat received from a concentrated solar power plant via the plurality of heat exchanging pipes and conducting the heat via the plurality of patterns into heat storing solids, and wherein the heat exchanger exchanges heat stored by heat storing solids via the plurality of patterns to the plurality of heat exchanging pipes for use by a heat consumer.

3. The heat exchanger as set forth in claim 1, wherein the outer diameter of each of the plurality of heat exchanging pipes ranges from 8 mm to 30 mm.

4. The heat exchanger as set forth in claim 1, wherein each of the plurality of heat exchanging pipes are made from a metallic material.

5. The heat exchanger as set forth in claim 1, wherein the number of heat exchanging pipes within the volume of the heat exchanger ranges from 1 to 10 volume percent.

6. The heat exchanger as set forth in claim 1, wherein the one or more heat conducting cables are Aluminum cables, stranded Aluminum cables or recycled Aluminum power cables.

7. The heat exchanger as set forth in claim 1, wherein the outer diameter of each of the one or more heat conducting cables ranges from 1 mm to 20 mm.

8. The heat exchanger as set forth in claim 1, wherein the heat storing solids are Basalt rocks, or Steelslag.

9. The heat exchanger as set forth in claim 1, wherein the sizes of the heat storing solids ranges from 1 mm to 100 mm.

10. The heat exchanger as set forth in claim 1, wherein the number of heat conducting cables and the number of heat storing solids combined within the volume of the heat exchanger ranges from 90 to 99 volume percent.

11. The heat exchanger as set forth in claim 1, wherein a charging and a discharging speed of a heat exchanger is about 50 kW/m³ or at least 50 kW/m³.

12. A system for thermal energy storage for urban concentrated solar power, comprising:
(a) a concentrated solar power plant producing heat;
(b) a heat consumer;
(c) a heat exchanger, wherein the heat exchanger received the heat from the concentrated solar power plant and generates an output to a heat consumer, wherein the heat exchanger comprises:
(i) a plurality of heat exchanging pipes distributed within a volume of the heat exchanger,
wherein the plurality of heat exchanging pipes runs in a direction more or less parallel to each other, and
wherein each of the plurality of heat exchanging pipes define an outer diameter;
(ii) a plurality of patterns distributed within the volume of the heat exchanger,
wherein each of the plurality of patterns pattern is formed by one or more heat conducting cables, and
wherein the one or more heat conducting cables form one of the plurality of patterns by connecting at least some of the plurality of heat exchanging pipes and by wrapping around the outer diameter of at least some of the plurality of heat exchanging pipes establishing contact surface area between one of the heat exchanging pipes and the one or more heat conducting cables; and
(iii) heat storing solids distributed within the volume of the heat exchanger and in between the plurality of heat exchanging pipes and plurality of patterns, wherein the heat storing solids are rocks of varying sizes.
